(19) United States
(12) Patent Application Publication
(10) Pub. No.: US 2022/0297358 A1
(43) Pub. Date: Sep. 22, 2022

(54) METHOD AND DEVICE FOR PRODUCING FOAM COMPOSITE ELEMENTS

(71) Applicant: Covestro Intellectual Property GmbH & Co. KG, Leverkusen (DE)

(72) Inventors: Horst-Uwe Jung, Kerpen (DE); Dirk Bruening, Leverkusen (DE); Achim Wick, Köln (DE); Dominik Hess, Leverkusen (DE)

(21) Appl. No.: 17/640,087

(22) PCT Filed: Oct. 6, 2020
(86) PCT No.: PCT/EP2020/078001

§ 371 Date: Mar. 3, 2022

(30) Foreign Application Priority Data
Oct. 11, 2019 (EP) 19202869.4

(51) Int. Cl. B29C 44/46; B29C 44/24

(52) U.S. Cl. CPC B29C 44/461; B29C 44/24; B29K 2995/0094; B29K 2105/0058

(57) ABSTRACT

A distributor bar for applying a liquid reaction mixture to a cover layer, comprising a distribution channel and multiple exit openings, the geometry of the exit openings in the distributor bar being chosen such that the discharged quantity at at least one end of the distributor tube is higher than in the center of the distributor bar. An application device containing the latter and a method for producing foam composite elements using this distributor bar are also provided.

### CROSS REFERENCE TO RELATED APPLICATIONS

This application is a U.S. national stage application, filed under 35 U.S.C. § 371, of International Application No. PCT/EP2020/078001, which was filed on Oct. 6, 2020, which claims priority to European Patent Application No. 19202869.4, which was filed on Oct. 11, 2019. The contents of each are hereby incorporated by reference into this specification.

### FIELD

The present invention relates to an applicator rake for applying a liquid reaction mixture to an outer layer comprising a distributor channel and a plurality of discharge openings, wherein the geometry of the discharge openings in the applicator rake is such that the discharge quantity at at least one end of the applicator rake is greater than in the central region of the applicator rake.

The invention likewise relates to a process and an apparatus for applying a foamable reaction mixture to a moving outer layer, wherein the reaction mixture is discharged from an application apparatus comprising at least one applicator rake according to the invention.

### BACKGROUND

Composite elements composed of at least one outer layer and an insulating core are nowadays employed in many fields of industry. The basic construction of such composite elements consists of at least one outer layer to which an insulating material is applied. Employable outer layers include for example sheets of coated steel, stainless steel, aluminum, copper or alloys of the two latter metals. Insulation panels made of a combination of outer layers and an insulating core may also be produced. Plastics films, aluminum films, wood, bitumen, glass fiber or mineral fiber nonwovens and also cellulose-containing materials such as paper, cardboard or papier-mâché may be used as outer layer materials. Multi-ply outer layers made of for example aluminum and paper are often employed. The choice of suitable outer layer material and individual layers (lower outer layer, insulating core, upper outer layer, optionally further intermediate layers) depends on the intended field of use of the composite elements or insulation panels and the resulting material specifications. Employable insulating cores include in particular foams based on polyurethane (PUR) and/or polyisocyanurate (PIR).

Insulation panels are often employed in the construction of houses or apartments. In addition to the use of composite elements for insulation of for example refrigerated warehouses, their use as façade elements on buildings or as elements of industrial doors, for example sectional doors, is also important. Such composite elements, also referred to hereinbelow as sandwich composite elements, exhibit through their outer layer a stability and surface appearance corresponding to the material employed, while the applied foam confers corresponding thermal insulation properties.

To produce corresponding insulation panels or composite elements, a foaming reaction mixture is applied to a provided outer layer by means of an application apparatus. To this end, for example in the use of foams based on polyurethane (PUR) and/or polyisocyanurate (PIR), the appropriate polyol components and isocyanate components are mixed with one another and applied to the outer layer on which they undergo foaming and curing.

Often used as the application apparatus for applying the foaming reaction mixture onto the outer layer are one or more tubes provided along their longitudinal extent with a plurality of discharge openings, for example drilled holes, from which the reaction mixture introduced into the tube may be discharged. Such tubes are typically referred to as applicator rakes.

The terms “applicator tube” and “applicator rake” are used synonymously hereinbelow. In the context of the present invention, the term “end of the applicator rake” is to be understood as meaning one of the two outer sections of the tube which corresponds in its longitudinal extent to a sector of not more than a quarter of the total length of the applicator rake. The “central region of the applicator rake” is to be understood as meaning the region between the two ends. The interior tube of the applicator rake which supplies the reaction mixture to the discharge openings is also referred to as the distributor channel.

EP 2 125 323 A discloses a process and an application apparatus, wherein application is carried out by means of a fixed tube provided with openings which runs parallel to the plane of the outer layer and perpendicular to the direction of motion of the outer layer. The liquid starting material for the isocyanate-based rigid foam is supplied in the middle of the tube provided with drilled holes. In a particular embodiment of the invention the diameter of the tube decreases from the middle towards the ends of the tube. The diameter of the discharge holes and/or the distance between the holes may also be reduced from the middle to the ends of the rake. These measures which are performed alone or in combination with one another are said to keep constant the velocity of the reaction mixture in the tube and during discharging through the holes, with the objective of obtaining a good surface structure (minimizing cavity formation). However, the reduction in the hole distances results in a reduced distance between the foam strands applied to the outer layer, thus resulting in earlier coalescence of the strands and consequently faster rising of the foam front relative to the other regions. Further reducing the hole distances increases the number of holes towards the end of the applicator rake, thus amplifying this effect. The nonuniform foam front results in crossflows upon contact with the upper outer layer, which results in inhomogeneous cell formation, lower compressive strength especially perpendicular to the outer layer and poorer surface quality.

EP 2 234 732 A discloses application using at least one fixed tube provided with openings which runs parallel to the plane of the outer layer and perpendicular to the direction of motion of the outer layer, wherein the openings have a diameter and a length, characterized in that the supply of the mixture is effected in the middle of the tube and the length of the openings decreases from the middle of the tube towards its ends. The length of the openings is preferably to be determined by a metal part attached at the opening on the underside of the tube. This measure too seeks to improve the surface structure of the foam and is also said to improve the adhesion between the outer layer and the rigid foam.

In order to be able to factor in as many of the parameters influencing discharge as possible, WO 2016/37842 finally proposes a process for designing applicator rakes whose geometry is configured using a 3D flow simulation (Computational Fluid Dynamics—CFD). Different process parameters such as for example panel width, flow rate, speed of the production line and a viscosity of the reaction mixture dependent on shear rate are fed into the calculation.

What these known applicator rakes or application apparatuses have in common is that they have been developed with the objective of ensuring the most uniform possible application of the reaction mixture over the width of the applicator rake. In particular, the foaming mixture is to be discharged from the openings of the tube/the applicator rake at the same discharge velocity and quantity irrespective of whether these openings are in the middle of the tube, i.e. near to the supply, or at the ends of the tube, i.e. further removed from the supply.

An important factor for the quality of insulation panels is especially complete formation of the panel edges. However, for production reasons the reaction mixture cannot be applied right up to the edge of the outer layer, especially if no side paper is used. In order to ensure that the reaction mixture is not partly applied next to the outerlayer, a sufficient minimum distance of the application apparatus from the edge is necessary. If the application apparatus terminates too close above the edges of the outerlayer, the reaction mixture may land next to the outerlayer, thus leading to product losses and to contamination of the plant. However, especially at high production speeds with rapidly reacting systems (generally known as “high-speed processes”) this has the result that the panel edges are often not completely formed by the foaming reaction mixture. If this problem is to be addressed with the hitherto known application apparatuses, this can only be achieved by increasing the overall discharge quantity. However, this results in higher material costs, higher weight of the insulation panels and poorer thermal insulation properties and is thus not a usable solution to this problem.

To solve this problem, DE 20 2011 001 109 U1 proposes the use of an applicator rake where the openings above the edge of the outer layer are mounted at an angle of 1° to 50° in the direction of the edge of the outer layer. However, the inclined discharge angle when the mixture impacts the outer layer in some cases leads to splashes or else to air inclusions which result in defects in the foam underside. The discharge velocity transverse to the transport direction of the outer layer increases with increasing inclination angle of discharge onto the outer layer and increasing discharge quantity, thus increasing the risk of the mixture leaving the outer layer laterally when no side paper is used or splashing up against the lateral delimitation of the outer layer. Both effects, the inclined impacting angle and the turbulent flow at the side, result in inhomogeneous cell formation and a nonuniform foam surface. Especially in the case of flexible outer layers (paper, metal foils, etc.) which are typically used in the production of insulation panels, the panel edges are then no longer sharp edged but rather exhibit undesired rounding. However, it is precisely this completely right-angled edge shape that is an important quality criterion in insulation panels. In addition, the foam surface often exhibits a valley at a certain distance from the edge. In the case of flexible outer layers, the constriction is visible as a large surface area sink mark on the top surfaces. The nonuniform cell structure often leads to channels and cavities in the surface. The inhomogeneous cell alignment at the side often also results in poorer thermal insulation properties and in lower compressive strength. Compressive strength is markedly higher when the cells are oriented perpendicular to the outer layer. This is especially favored when the foam only foams in the thickness direction and ideally no lateral flow occurs.

Furthermore, when discharging at an angle in the direction of the edge of the outer layer as proposed in DE 20 2011 001 109 U1, the velocity component transverse to the transport direction has the result that the distance between the outer material strand and the lateral delimitation of the outer layer depends on the vertical distance between the applicator rake and the outer layer. A height of the applicator rake which is not optimally adjusted can easily have the result that at an excessively low position, the distance from the outer layer is too low and the corners are thus not completely filled or at an excessively high position, the material leaves the outer layer laterally. The height is also subject to the limitations of commonly used production plants. Furthermore, the magnitude of the velocity component transverse to the transport direction and thus the distance between the outer material strand and the lateral delimitation depends on the discharge quantity so that different discharge quantities in each case require a new optimal height to be found. The abovementioned points significantly hamper the efficient utilization of applicator rakes having laterally angled discharge openings.

### SUMMARY

Starting from the deficits of the applicator rakes of the prior art, it is thus an object of the present invention to provide an apparatus and a process which allows the quality of insulation panels to be further improved especially in terms of complete formation of the panel edges.

According to the invention the object is achieved by an applicator rake as claimed in claim 1, by an application apparatus as claimed in claim 9 and by a process as claimed in claim 14. Advantageous embodiments are specified in the subclaims.

### BRIEF DESCRIPTION OF FIGURES

In the figures:

FIG. 1 shows an inventive applicator rake of type A 510

FIG. 2 shows an inventive applicator rake of type B 520

FIG. 3 shows an enlarged view of section 900 of FIGS. 1 and 2

FIG. 4 shows an application apparatus consisting of an inventive applicator rake of type A 510

FIG. 5 shows an application apparatus consisting of two applicator rakes of type B 520 and a conventional applicator rake 500

FIG. 6 shows an application profile of the apparatus from FIG. 4

FIG. 7 shows an application profile of the apparatus from FIG. 5

### DETAILED DESCRIPTION

In a first aspect the present invention relates to an applicator rake for application of a liquid reaction mixture to an outer layer comprising a distributor channel and a plurality of discharge openings, wherein the geometry of the discharge openings in the applicator rake is such that the average discharge quantity per unit length along the longitudinal extent of the applicator rake is at at least one end of the applicator rake 1.1 to 3 times, preferably 1.2 to 2 times, very particularly preferably 1.5 to 2 times, greater than the average discharge quantity per unit length in the central region of the applicator rake.

In the context of the present invention, “end of the applicator rake” is to be understood as meaning in one embodiment the outer quarter or less, in a further embodiment the outer fifth or less, in a particularly preferred embodiment the outer sixth or less, of the tube of the applicator rake in its longitudinal extent.

In the context of the present invention, the region between the two ends of the applicator rake is also referred to as the “central region of the applicator rake”. In the present invention the term “discharge quantity” is to be understood as meaning the quantity of liquid reaction mixture which in steady-state operation is discharged through the discharge openings of the applicator rake at at least the flow rate specified by fluid mechanics. The average discharge quantity per unit length at the at least one end of the applicator rake is calculated by dividing the total quantity discharged through the discharge openings in the end region by the length of the applicator tube section which constitutes the end of the applicator rake. This calculation also applies to the average discharge quantity per unit length in the central region.

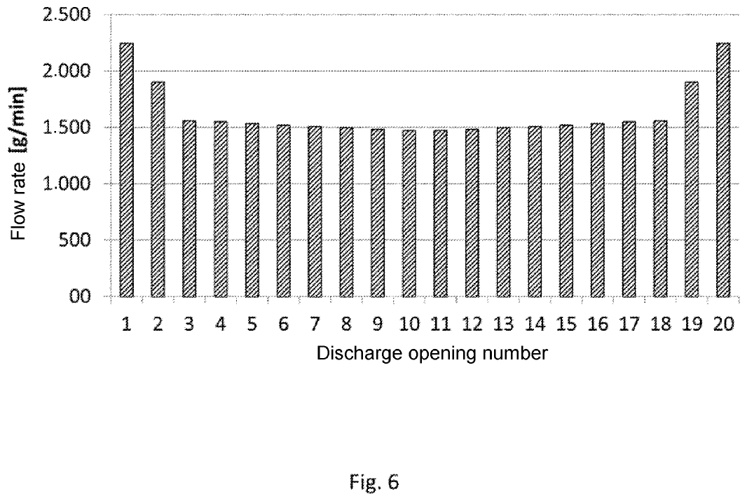

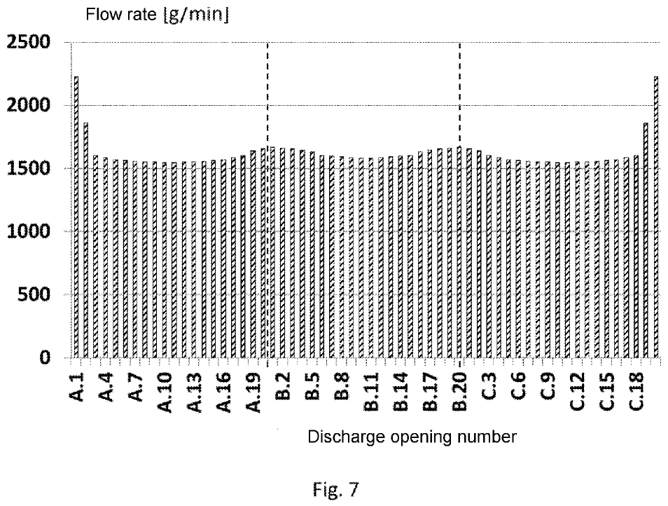

The geometry of the discharge openings is determined by the desired discharge profile which is obtained by graphically plotting the flow rate (discharge quantity/unit time) against the position of the discharge opening in the applicator rake. In embodiments with an increased discharge quantity at only one end of the applicator rake, this therefore results in an asymmetric discharge profile having elevated flow rates on one side (see also FIG. 7, left-hand and right-hand third). In embodiments with an increased discharge quantity at both ends of the applicator rake, this results in a discharge profile having elevated flow rates on both sides (see FIG. 6); in a preferred case the discharge profile is symmetrical, as obtained in the case of a mirror-symmetric arrangement of the discharge openings and a central supply.

The tube of the applicator rake provided with the discharge openings may have a substantially constant cross section. For manufacturing reasons and for optimal flow conditions, a circular cross section is preferred. However, to reduce residence time it is also possible to employ a tube having a reducing cross section from the feed of the reaction mixture to the outer discharge opening at the tube end. Residence time is to be understood as meaning the time required by the reaction mixture to flow from entry into the applicator rake to discharge from the respective discharge opening.

The supply of the liquid reaction mixture into the distributor channel may be effected either centrally or at one end. It is preferable when said supply is effected centrally.

The geometry of the discharge openings (hereinbelow also referred to as “hole” or “holes”) is determined by the respective cross-sectional area of the opening FA and the length of the opening LA.

It is preferable to effect the increase in the quantity to be discharged by increasing the average cross-sectional area FA at at least one end of the applicator rake. It is particularly preferable when the cross-sectional area is circular; in this case the area may be described in terms of its diameter DA.

The increase in the average discharge quantity per unit length at at least one end of the applicator rake is preferably achieved by making the cross-sectional area FA of at least one, preferably at least two, of the discharge openings at the at least one end of the applicator rake 1.05 to 2 times, preferably 1.1 to 1.75 times and particularly preferably 1.1 to 1.5 times larger than the average cross-sectional area of the discharge openings in the central region of the applicator rake.

When the discharge openings have a round cross section, the increase in the average discharge quantity per unit length at the at least one end of the applicator rake is preferably achieved by making the diameter DA of at least one, preferably at least two, of the discharge openings at the at least one end 1.025 to 1.41 times, preferably 1.05 to 1.35 times and particularly preferably 1.1 to 1.25 times larger than the average diameter of the discharge openings in the central region of the applicator rake.

An increase in the discharge quantity per unit length may also be achieved by reducing the hole length LA. The prior art describes reducing the hole length as a means to establish the most constant possible application quantity and velocity over the width of the applicator. However, it has now been found that, surprisingly, a reduction in the length LA going beyond that described in the prior art is advantageous. An increase in the average discharge quantity per unit length may also be achieved by reducing the distance between the discharge openings in the region of the at least one end of the applicator rake compared to the distance between the discharge openings in the central region of the applicator rake. In a preferred embodiment, the average distance between the discharge openings in the region is less than 0.9 times the distance between the discharge openings in the central region, in a preferred embodiment less than 0.75 times, in a yet more preferred embodiment less than 0.5 times.

It is especially also possible to achieve an increase in the average discharge quantity per unit length by a combination of two or three of the above-described measures of cross-sectional area increasing, hole length reduction and distance reduction.

In a particularly preferred embodiment, the geometry of the outer discharge openings is at at least one end of the applicator rake altered such that, compared to the inner discharge openings, the average cross-sectional area FA is increased and its average length LA is reduced.

Disposed at one end of the applicator rake or at both ends of the applicator rake are in each case preferably 1 to 6 discharge openings (also referred to as “outer discharge openings”), in particular 1 to 4 openings and very particularly 1 to 2 openings, whose geometry differs from the geometry of the openings in the central region of the applicator rake as described above. The discharge quantities for the outer discharge openings are 1.1 to 3 times, particularly preferably 1.2 to 2 times, the quantities for the other discharge openings.

The tuning of the size ratios and geometries of the components of the applicator apparatus involved in conducting the reaction mixture is carried out for example with computer assistance, preferably with a CFD calculation.

In a first embodiment both tube ends have discharge openings whose geometry is configured such that the quantity of liquid reaction mixture dischargeable through the discharge openings (discharge quantity) is greater than the quantity dischargeable through the further inward or middle discharge openings (also referred to hereinbelow as “applicator rake type A”). The change in the geometry of the discharge openings from the middle towards the two outer ends is identical but may also be different. In the application apparatus for producing a composite element from at least one outer layer and a core layer, this applicator rake is arranged such that the reaction mixture is applied as close as possible to both edges of the outer layer from the enlarged discharge openings at both ends of the applicator tube, i.e. substantially transverse to the direction of motion of the outer layer (i.e. the direction of motion of the outer layer and the longitudinal axis of the applicator rake form an angle of >60°, preferably >80° and particularly preferably an angle >85°). This first embodiment of the applicator rake according to the invention is employed in an application apparatus especially when the width of the outer layer to be covered is the same as or only slightly wider (preferably less than 20% wider) than the length of the tube of the applicator rake. The application apparatus then comprises precisely one applicator rake.

In a second embodiment, the applicator rake comprises an applicator tube having a plurality of discharge openings, wherein the geometry of the discharge openings is configured such that the discharge quantity at the discharge openings at precisely one end of the applicator rake is greater than at the other discharge openings (also referred to hereinbelow as “applicator rake type B”). The geometry of the discharge openings is thus different at both ends of the applicator tube, i.e. always asymmetric viewed from the middle of the applicator tube. The feeding of the reaction mixture may in this case be effected in the middle of the applicator tube or at one end of the applicator tube, for example at the end without the increased discharge quantities. Feeding is preferably effected into the middle of the applicator tube.

This second embodiment of the applicator rake is preferably positioned in the application apparatus for producing a composite element from at least one outer layer and one core layer such that the reaction mixture is discharged from the discharge openings having the increased hole diameters towards the edge of the outer layer. This applicator rake is preferably combined in the application apparatus with further applicator rakes to cover the entire outer layer width.

In a particularly preferred embodiment, the application apparatus comprises two of these applicator rakes of the second embodiment, wherein these are arranged such that the ends with the increased discharge quantities each effect application to a respective edge of the outer layer.

Further conventional, symmetric applicator rakes may be arranged between these two applicator rakes, wherein these preferably have discharge openings with substantially identical discharge quantity distributions (i.e. with less than about 10% variation from their average value). Employable here are for example the known conventional symmetrical applicator rakes having constant diameters from the prior art. The applicator rakes may be for example in the form of an individual applicator rake or applicator rake pairs, as described for example in EP 1 857 248 A2, EP 2 614 944 A1 or EP 2 804 736 A1. When using a plurality of applicator rakes these may be arranged either in a line or else optionally slightly offset one behind another in the direction of motion of the outer layer, in order that the reaction mixture discharged from the discharge openings of an applicator tube at least partially contacts the reaction mixture discharged from the discharge openings of the other applicator tube. Possible arrangements of applicator tubes in application apparatuses may be as described in WO 2018/141731, WO 2018/141720 or WO 2018/141735.

According to the invention, the application apparatus thus employs either a) precisely one applicator rake having discharge openings with increased discharge quantities at both ends of the applicator tube (applicator rake type A) or b) at least one, preferably two, applicator rakes having discharge openings with increased discharge quantities at precisely one end of the applicator tube (applicator rake type B), optionally in combination with at least one symmetrical applicator rake with substantially constant discharge quantities. According to the invention, variant b) preferably comprises combining two applicator rakes of type B according to the invention with a conventional applicator rake.

The number of discharge openings depends on the width of the applicator rake and is thus hereinbelow reported in units of [l/m], wherein the length in meters refers to the length of the distributor channel.

The number of discharge openings in the apparatus according to the invention is preferably 12/m to 125/m, particularly preferably 25/m to 100/m and very particularly preferably 30/m to 75/m.

In a preferred embodiment, the width of the applicator rake is about 400 mm.

In the simplest case, the discharge openings are a drilled hole in the tube. The drilled holes preferably run perpendicular to the tube axis and the applicator rake/the applicator rakes are preferably attached such that the liquid reaction mixture is applied to the outer layer substantially vertically, i.e. at an angle of 90°+/−10°, preferably 90°+/−5°.)

In the case of circular discharge openings, the diameter DA is preferably in the range between 1 mm and 8 mm, particularly preferably between 1.2 mm-6 mm and in particular between 1.3 mm-5 mm.

It is also possible to increase the length of the discharge openings, for example via tubelets attached vertically to the applicator tube at the discharge openings. The length LA of the discharge openings is to be understood as meaning the distance from the edge of the opening on the inside of the distributor channel to the point at which the reaction mixture flows out of the tube. Another less preferred option for extending the discharge openings is described in DE 20 2011 001 109 U1, [0036].

The length of the discharge openings LA is preferably >1 to <100 mm, particularly preferably >1 to <50 mm and in particular >3 to <35 mm.

The interior tube of the applicator rake is also referred to as a distributor channel since it distributes the reaction mixture from the feed to the discharge openings. The cross-sectional area of the distributor channel may be constant and, since for manufacturing reasons and for optimal flow conditions a circular design is preferred, the diameter may, for example, be 5-25 mm, preferably 5-15 mm and in particular 6 to 12 mm. Alternatively the distributor channel cross section may also decrease from the feed towards the end of the applicator tube. In the case of the preferred circular design, the diameter at the end of the distributor channel is for example 30-100% of the diameter at the feed, preferably 60-100%.

The distance between the individual discharge openings is preferably constant and depends on the total length of the applicator rake and the number of discharge openings. Alternatively, the discharge quantity at the end of the applicator rake may also be increased when the distance between the discharge openings decreases towards the end. However, this design often results in the abovementioned problems.

The process according to the invention using the discharge apparatus according to the invention is preferably a continuous process. It is suitable for the production of foam composite elements such as insulation panels in a high-speed production procedure. The process for continuous production of foam composite elements comprising a polyurethane (PUR) or polyurethane/polyisocyanurate (PUR/PIR) foam core layer is known per se, for example, from the prior art cited hereinabove. Depending on thickness, the outer layer speed is, for example, ≥10 meters per minute, preferably ≥15 meters per minute, more preferably ≥30 meters per minute.

The application apparatus is used to apply the liquid reaction mixture to the continuously moving outer layer. The feed to the applicator tube/the applicator tubes may be central or lateral for example. The applicator tubes receive a product stream produced from a polyol component and an isocyanate component in one or more mixing heads.

Suitable outer layers or substrates include, for example, metal foils, in particular aluminum foils, bitumen foils and multilayer outer layers, for example made of aluminum and paper, and plastic films. There is generally no limit to the width of the outer layer. For example, the cover layer may have a width between 1000 and 1300 mm, but a width of 2400 mm is also possible.

Suitable reaction mixtures include in particular a mixture which reacts to afford a polyurethane and/or polyisocyanurate foam. In one embodiment of the process according to the invention, the reaction mixture therefore comprises

a polyisocyanate B), and

an isocyanate-reactive composition A), containing
at least one polyol A1) and
optionally other isocyanate-reactive compounds A2), and
optionally additives and auxiliaries A3) such as, for example, stabilizers and flame retardants,

optionally catalysts D), and

one (or more) blowing agents C).

The polyol A) is preferably selected from the group of the polyether polyols, polyester polyols, polycarbonate polyols and/or polyether ester polyols. The OH number of the employed polyol or of the employed polyols may be for example >15 mg KOH/g to <800 mg KOH/g and the average OH functionality of the employed polyol or the employed polyols is ≥1.5. In the case of a single added polyol, the OH number indicates the OH number of said polyol. In the case of mixtures, the average OH number is reported. This value can be determined according to DIN 53240-2 (1998). The average OH functionality of the polyols is, for example, in a range from ≥1.5 to <6.

Examples of polyether polyols that can be used are polytetramethylene glycol polyethers of the type obtainable via polymerization of tetrahydrofuran by means of cationic ring-opening. Suitable polyether polyols likewise include addition products of styrene oxide, ethylene oxide, propylene oxide, butylene oxides and/or epichlorohydrin onto di- or polyfunctional starter molecules. It is usual to employ polyether polyols with ethylene oxide or propylene oxide as chain extenders.

Suitable starter molecules are, for example, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, 1,4-butanediol, 1,6-hexanediol and low molecular weight hydroxyl-containing esters of such polyols with dicarboxylic acids.

Employable polyester polyols include inter alia polycondensates of di- and also tri- and tetraols and di- and also tri- and tetracarboxylic acids or hydroxycarboxylic acids or lactones. Also employable instead of the free polycarboxylic acids are the corresponding polycarboxylic anhydrides or corresponding polycarboxylic esters of lower alcohols for producing the polyesters.

Examples of suitable diols are ethylene glycol, butylene glycol, diethylene glycol, triethylene glycol, polyalkylene glycols such as polyethylene glycol, and also 1,2-propanediol, 1,3-propanediol, 1,3-butanediol, 1,3-butanediol, 1,6-hexanediol and isomers, neopentyl glycol or neopentyl glycol hydroxypivalate. Also employable in addition are polyols such as trimethylolpropane, glycerol, erythritol, pentaerythritol, trimethylolbenzene or trishydroxyethyl isocyanurate.

Examples of polycarboxylic acids that may be used include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid or trimellitic acid. It is also possible to use the corresponding anhydrides as the acid source.

The employed polycarboxylic acids may also be admixed with monocarboxylic acids and derivatives thereof. Also contemplated in particular are bio-based starting materials and/or derivatives thereof, for example castor oil, polyhydroxy fatty acids, ricinoleic acid, stearic acid, soybean oil fatty acid, hydroxy-modified oils, grapeseed oil, black cumin oil, pumpkin kernel oil, borage seed oil, soybean oil, wheat germ oil, rapeseed oil, sunflower kernel oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified and epoxidized fatty acids and fatty acid esters, for example based on myristoleic acid, palmitoleic acid, oleic acid, vaccenic acid, petroselic acid, gadoleic acid, erucic acid, nervonic acid, linoleic acid, alpha- and gamma-linolenic acid, stearidonic acid, arachidonic acid, timnodonic acid, clupanodonic acid and cervonic acid.

Examples of hydroxycarboxylic acids that may be used as co-reactants in the preparation of a polyester polyol having terminal hydroxyl groups include hydroxycaproic acid, hydroxybutyric acid, hydroxydecanoic acid, hydroxystearic acid and the like. Suitable lactones include caprolactone, butyrolactone and homologs.

Employable polycarbonate polyols include hydroxyl-containing polycarbonates, for example polycarbonate diols. These are obtainable by reaction of carbonic acid derivatives, such as diphenyl carbonate, dimethyl carbonate or phosgene, with polyols, preferably diols, or from carbon dioxide.

Examples of such diols are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A, and lactone-modified diols of the aforementioned type. Polyether polycarbonate diols may also be employed instead of or in addition to pure polycarbonate diols.

Employable polyether ester polyols are compounds containing ether groups, ester groups and OH groups. Organic dicarboxylic acids having up to 12 carbon atoms are suitable for producing the polyetherester polyols, preferably aliphatic dicarboxylic acids having >4 to <6 carbon atoms or aromatic dicarboxylic acids used singly or in admixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. Derivatives of these acids that may be used include, for example, their anhydrides and also their esters and monoesters with low molecular weight monofunctional alcohols having >1 to <4 carbon atoms.

Component A) may additionally comprise further isocyanate-reactive compounds A2), for example low molecular weight isocyanate-reactive compounds. Preferably employable are di- or trifunctional amines and alcohols, preferably diols and/or triols having molar masses Mₙ of less than 400 g/mol, in particular of 60 to 300 g/mol, for example triethanolamine, diethylene glycol, ethylene glycol and glycerol. Where such low molecular weight isocyanate-reactive compounds are used for producing the rigid polyurethane and/or polyisocyanurate foams, for example in the capacity of chain extenders and/or crosslinkers, these are advantageously employed in an amount of up to 5% by weight based on the total weight of component A.

Component A2) also comprises all other isocyanate-reactive compounds, for example graft polyols, polyamines, polyamino alcohols, polythiols and/or bio-based compounds having isocyanate-reactive groups such as castor oil and its components.

It is understood that the above-described isocyanate-reactive compounds may also include compounds having mixed functionalities.

Additives A3) optionally employable in polyurethane chemistry are known to those skilled in the art. These are for example foam stabilizers, suitable examples of which especially include polyether siloxanes. The construction of these compounds is generally such that a copolymer of ethylene oxide and propylene oxide is attached to a polydimethylsiloxane radical. Substances of this type are commercially available, for example as Struksilon 8031 from Schill+Seilacher or else TEGOSTAB® B 8443 from Evonik. Silicone-free stabilizers, such as for example LK 443 from Air Products, may also be employed.

Flame retardants are often also employed, preferably in an amount of 5% to 50% by weight based on the total amount of compounds having isocyanate-reactive hydrogen atoms in the polyol component, in particular 7% to 35% by weight, particularly preferably 8% to 25% by weight. Flame retardants are known in principle to those skilled in the art and are described, for example, in “Kunststoffhandbuch”, volume 7 “Polyurethane”, chapter 6.1. These may be, for example, brominated and chlorinated polyols or phosphorus compounds such as the esters of orthophosphoric acid and of metaphosphoric acid, which may likewise contain halogen. It is preferable to choose flame retardants that are liquid at room temperature. Recent developments include environmentally friendly products.

Examples of suitable polyisocyanates B) include 1,4-butylene diisocyanate, 1,5-pentane diisocyanate, 1,6-hexamethylene diisocyanate (HDI), isophorone diisocyanate (IPDI), 2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) or higher homologs (polymeric MDI, pMDI), 1-3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) having C1 to C6-alkyl groups.

In addition to the abovementioned polyisocyanates, it is also possible to use proportions of modified diisocyanates having a uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

It is possible that in the reaction mixture the number of NCO groups in the isocyanate and the number of isocyanate-reactive groups result in an index of 110 to 600, preferably between 115 and 400. This index may also be in a range from >180:100 to <330:100 or else >90:100 to <140:100.

The reaction mixture further contains sufficient blowing agent C) as is required for achieving a dimensionally stable foam matrix and the desired apparent density. This is generally 0.5-30 parts by weight of blowing agent based on 100 parts by weight of the component A. Preferably employed blowing agents are physical blowing agents selected from at least one member of the group consisting of hydrocarbons, halogenated ethers and perfluorinated hydrocarbons having 1 to 8 carbon atoms. In the context of the present invention, “physical blowing agents” are to be understood as meaning compounds which, on account of their physical properties, are volatile and unreactive toward the isocyanate component. The physical blowing agents to be used according to the invention are preferably selected from hydrocarbons (for example n-pentane, isopentane, cyclopentane, butane, isobutane), ethers (for example methylal), halogenated ethers, perfluorinated hydrocarbons having 1 to 8 carbon atoms (for example perfluorohexane) and mixtures thereof with one another. Also preferred is the use of (hydro)fluorinated olefins, for example HFO 1233zd(E) (trans-1-chloro-3,3,3-trifluoro-1-propene) or HFO 1336mzz(Z) (cis-1,1,1,4,4,4-hexafluoro-2-butene) or additives such as FA 188 from 3M (1,1,1,2,3,4,5,5,5-nonafluoro-4-(trifluoromethyl)pent-2-ene) and the use of combinations of these blowing agents. In particularly preferred embodiments the blowing agent C) employed is a pentane isomer or a mixture of different pentane isomers. It is exceptionally preferable to employ cyclopentane as the blowing agent C). Further examples of preferably employed hydrofluorocarbons are for example HFC 245fa (1,1,1,3,3-pentafluoropropane), HFC 365mfc (1,1,1,3,3-pentafluorobutane), HFC 134a or mixtures thereof. Different blowing agent classes may also be combined.

Also especially preferred is the use of (hydro)fluorinated olefins, for example HFO 1233zd(E) (trans-1-chloro-3,3,3-trifluoro-1-propene) or HFO 1336mzz(Z) (cis-1,1,1,4,4,4-hexafluoro-2-butene) or additives such as FA 188 from 3M (1,1,1,2,3,4,5,5,5-nonafluoro-4 (or 2)-(trifluoromethyl)pent-2-ene and/or 1,1,1,3,4,4,5,5,5-nonafluoro-4 (or 2)-(trifluoromethyl)pent-2-ene), alone or in combination with other blowing agents. These have the advantage of having a particularly low ozone depletion potential (ODP) and a particularly low global warming potential (GWP). The process according to the invention allows advantageous employment of (hydro)fluorinated olefins as blowing agents for composite systems since it allows production of composite elements having improved surface structures and improved adhesion to the outer layer compared to composite elements produced with other application techniques.

Also employable in addition or as an alternative to the abovementioned physical blowing agents are chemical blowing agents (also known as “co-blowing agents”). These are particularly preferably water and/or formic acid. The chemical blowing agents are preferably employed together with physical blowing agents. It is preferable when the co-blowing agents are employed in an amount up to 6% by weight, particularly preferably 0.5% to 4% by weight, for the composite elements based on the total amount of compounds having isocyanate-reactive hydrogen atoms in the component A.

Preferably employed for composite elements is a mixture of 0 and 6.0% by weight of co-blowing agent and 1.0% to 30.0% by weight of blowing agent in each case based on 100% by weight of the component A. However, the quantity ratio of co-blowing agent to blowing agent may also be from 1:7 to 1:35 according to requirements.

The reaction mixture optionally further contains a catalyst component D) which is suitable for catalyzing the blowing reaction, the urethane reaction and/or the isocyanurate reaction (trimerization). The catalyst components may be metered into the reaction mixture or else initially charged in the isocyanate-reactive component A) in full or in part.

Suitable therefor are in particular one or more catalytically active compounds selected from the following groups:

D1) aminic catalysts, for example amidines, such as 2,3-dimethyl-3,4,5,6-tetrahydropyrimidine, tertiary amines, such as triethylamine, tributylamine, dimethylcyclohexylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine-1,6, pentamethyldiethylenetriamine, bis(2-dimethylaminoethyl) ether, bis(dimethylaminopropyl)urea, dimethylpiperazine, 1,2-dimethylimidazole, N,N′,N″-tris(dimethylaminopropyl)hexahydrotriazine, bis[2-(N,N-dimethylamino)ethyl] ether, 1-azabicyclo-(3,3,0)-octane and 1,4-diazabicyclo-(2,2,2)-octane, and alkanolamine compounds, such as triethanolamine, triisopropanolamine, N-methyl- and N-ethyldiethanolamine, N,N-dimethylaminoethoxyethanol, N,N,N′-trimethylaminoethylethanolamine and dimethylethanolamine. Particularly suitable compounds are selected from the group comprising tertiary amines, such as triethylamine, tributylamine, dimethylcyclohexylamine, dimethylbenzylamine, N,N,N′,N′-tetramethylethylenediamine, pentamethyldiethylenetriamine, bis(2-dimethylaminoethyl) ether, dimethylpiperazine, 1,2-dimethylimidazole and alkanolamine compounds, such as tris(dimethylaminomethyl)phenol, triethanolamine, triisopropanolamine, N-methyl- and N-ethyldiethanolamine, N,N-dimethylaminoethoxyethanol, N,N,N′-trimethylaminoethylethanolamine and dimethylethanolamine.

In a particularly preferred embodiment, the catalyst component employs one or more aminic compounds having the following structure:

(CH₃)₂N—CH₂—CH₂—X—CH₂—CH₂—Y

wherein Y=NR₂ or OH, preferably Y=N(CH₃)₂ or OH, particularly preferably Y=N(CH₃)₂

and wherein X=NR or O, preferably X=N—CH₃ or O, particularly preferably X=N—CH₃. Every R can be chosen independently of every other R and represents an organic radical of any desired structure having at least one C atom. R is preferably an alkyl group having 1 to 12 carbon atoms, in particular C1- to C6-alkyl, particularly preferably methyl and ethyl, in particular methyl.

D2) Carboxylates of alkali metals or alkaline earth metals, in particular sodium acetate, sodium octoate, potassium acetate, potassium octoate, and tin carboxylates, for example tin(II) acetate, tin(II) octoate, tin(II) ethylhexanoate, tin(II) laurate, dibutyltin diacetate, dibutyltin dilaurate, dibutyltin maleate and dioctyltin diacetate, and ammonium carboxylates. Sodium, potassium and ammonium carboxylates are especially preferred. Preferred carboxylates are formates, ethylhexanoates (=octoates) and acetates.

The catalyst preferably contains one or more catalysts selected from the group consisting of potassium acetate, potassium octoate, pentamethyldiethylenetriamine, N,N′,N″-tris(dimethylaminopropyl)hexahydrotriazine, tris(dimethylaminomethyl)phenol, bis[2-(N,N-dimethylamino)ethyl] ether and N,N-dimethylcyclohexylamine, particularly preferably from pentamethyldiethylenetriamine, N,N′,N″-tris(dimethylaminopropyl)hexahydrotriazine and N,N-dimethylcyclohexylamine, particularly preferably from pentamethyldiethylenetriamine, N,N′,N″-tris(dimethylaminopropyl)hexahydrotriazine and N,N-dimethylcyclohexylamine in combination with potassium acetate, potassium octoate or potassium formate or sodium formate.

The catalysts required for producing the rigid foam, in particular aminic catalysts (D1) in conjunction with salts employed as trimerization catalysts, are in a preferred embodiment employed in such an amount that, for example in continuous production plants, elements with flexible outer layers may be produced at speeds customary for high-reactivity systems depending on element thickness.

The reactivity of the reaction mixture is generally adapted to the requirements by means of the catalyst (or via other reactivity-increasing components, for example aminopolyethers). Production of thin panels thus requires a reaction mixture having a higher reactivity than production of thicker panels. Cream time and gel time are respectively typical parameters for the time taken for the reaction mixture to begin to react and for the point at which a sufficiently stable polymer network has been formed. Typical cream times (characterized by commencement of foaming of the reaction mixture upon visual inspection) for processing using conventional techniques are in the range from 2 seconds to 50 seconds.

The process according to the invention also allows advantageous processing of reaction mixtures having high or relatively high reactivities, i.e. cream times of <5 s, in particular <2 s, very particularly <1 s, and gel times of <25 s, in particular <20 s and very particularly <14 s. The process according to the invention may be advantageous in particular for the production of thin panels since little material is available for coalescence here.

It is preferable to use a combination of catalyst components D1 and D2 in the reaction mixture. In this case the molar ratio should be chosen such that the D2/D1 ratio is between 0.1 and 80, in particular between 2 and 20. Short gel times may be achieved, for example, with more than 0.9% by weight of potassium 2-ethylhexanoate based on all components of the reaction mixture.

In all of the recited application apparatuses, application may be effected in or counter to the direction of motion of the outer layer. Even in an embodiment with two or more applicator rakes, it may be advantageous for not all of the applicator tubes to be placed at the same angle to the outer layer.

The application apparatuses according to the invention comprising one or more applicator rakes which exhibit increased discharge quantities at one end or both ends make it possible to produce composite elements which, compared to standard apparatuses of the prior art, exhibit improved edge formation without the recited quality disadvantages.

### Preferred Exemplary Embodiments

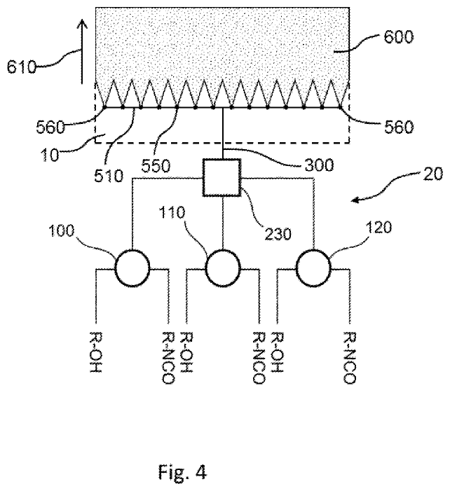

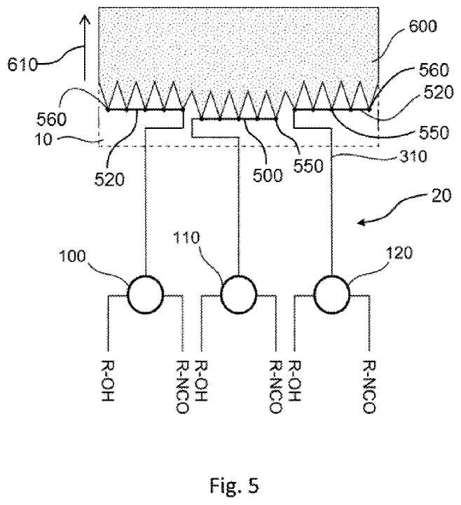

Further measures improving the invention are hereinbelow more particularly elucidated with reference to the figures together with the description of a preferred exemplary embodiment of the invention. FIGS. 4 and 5 show apparatuses according to the invention during performance of processes according to the invention. Shown in FIG. 6 by way of example is an application profile of an application apparatus comprising an applicator rake of type A and in FIG. 7 an application profile of an application apparatus comprising two applicator rakes of type B and an interposed conventional applicator rake.

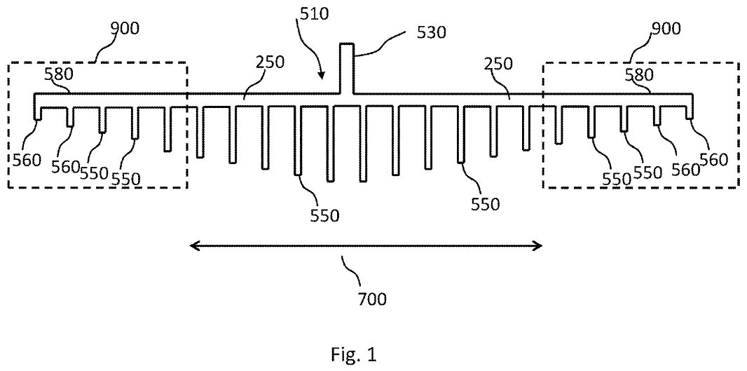

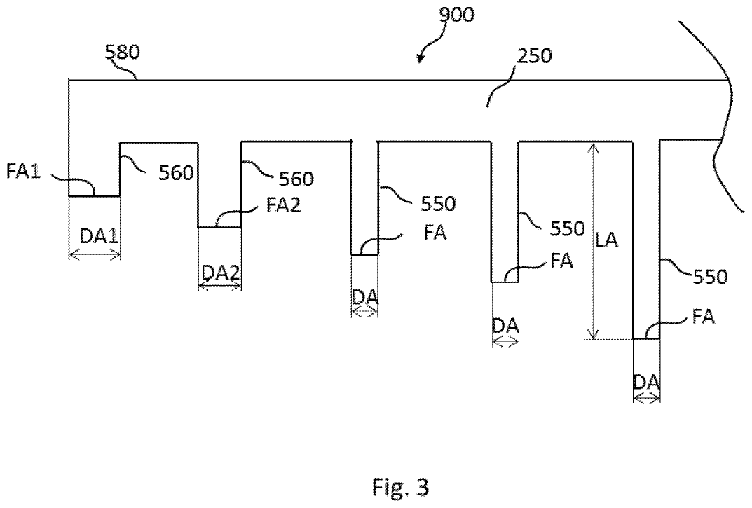

FIG. 1 shows a schematic diagram of an applicator rake of type A 510 having a central feed 530 of the liquid reaction mixture into the distributor channel 250. The two ends 580 of the applicator rake 510 comprise inter alia discharge openings 560, through which a greater discharge quantity may be discharged than from the other discharge openings 550. FIG. 3 shows an enlarged view of section 900.

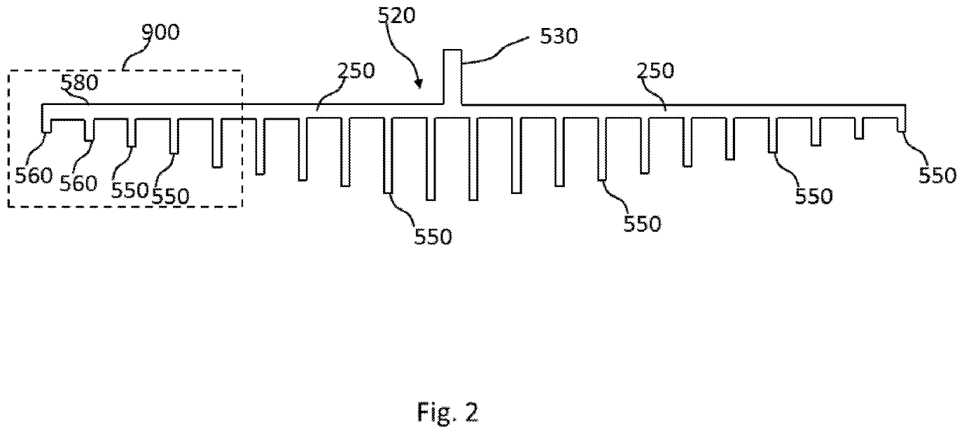

FIG. 2 shows a schematic diagram of an applicator rake of type B 520 having a central feed 530 of the liquid reaction mixture into the distributor channel 250. In this applicator rake only the end 580 has the discharge openings with increased discharge quantity 560. FIG. 3 shows an enlarged view of section 900.

FIG. 3 shows an enlarged view of an end 580 with the outer discharge openings of a symmetrical applicator rake [section 900, FIG. 1] or the end 580 having the enlarged discharge openings of an asymmetrical applicator rake [section 900, FIG. 2]. In this example, the two outer discharge openings 560 have increased diameters DA1 and DA2 compared to the further inward discharge openings 550 having diameter DA, thus also resulting in increased surface areas of the discharge openings (FA1 and FA2) compared to the surface areas FA of the inward discharge openings 550.

FIG. 4 shows a schematic view of a plant for operating a process used for producing composite elements. The plant has a double-belt transport system having an application apparatus 20 for applying a foaming reaction mixture 600 to an outer layer 10, into which a lower outer layer 10 whose contour is shown in dashed lines and a further upper outer layer (not shown) feed. The applicator rake 510 and the outer layer 10 are movable relative to one another in the direction of motion of the outer layer 610. The mixing heads 100, 110, 120 each combine their reactant streams (here labeled R—OH and R—NCO) into product streams which are supplied to a distributor 230 connected to the mixing heads. The product streams thus contain the foamable polyurethane reaction mixture. The distributor 230 homogenizes the product streams so that, for example, differences in the progress of the reaction over time or differences in the properties of the reactant streams over time are compensated. Differences in the properties of the reactant streams over time may be, for example, differences as a consequence of density variations or of variations in the conveying power of the reactant streams to the mixing heads. The reaction mixture exits the distributor 230 via the discharge conduit 300 which terminates in the applicator rake 510 having the discharge openings 550 and 560.

In this first embodiment of the invention, the discharge apparatus 20 comprises precisely one applicator rake of type A 510, as shown for example in FIG. 1. The change in diameter of the discharge openings is preferably symmetrical from the middle to the two outer ends. In the variant shown, only a single applicator rake is used for discharge, wherein the length of the applicator rake is approximately equal to the width of the outer layer. However, especially at large outer layer widths, the greater length of the applicator rake results in longer flow paths and thus in a greater pressure drop and higher residence times than when using a plurality of applicator rakes, with the result that the process having only one applicator rake is preferably employed at smaller outer layer widths. In the embodiment shown in FIG. 1, the supply of the reaction mixture is therefore preferably effected in the middle of the symmetrical applicator rake according to the invention to reduce residence time and pressure drop as far as possible.

FIG. 5 shows a possible arrangement of a plurality of applicator rakes in an application apparatus, wherein the applicator rakes 500, 520 and the outer layer 10 are movable relative to one another in the direction of motion of the outer layer 610. It shows an application apparatus 24 for applying a foaming reaction mixture 600 to an outer layer 10, in particular for producing a composite element. A marked improvement in the edge formation of an insulation panel is to be expected when the two outer applicator rakes 520 employed are the inventive asymmetrical applicator rakes of type B, for example analogous to FIG. 2, with increased discharge quantities at their outer ends.

The end with the higher discharge quantity of the asymmetric applicator rakes is in each case arranged right at the outside to allow application of more material towards the edge of the outer layer. If necessitated by the total discharge width, a conventional applicator rake 500 is additionally employed in the middle as shown in FIG. 5. It is also possible to employ a plurality of conventional applicator rakes depending on the width of the outer layer. At narrower outer layer widths, the middle applicator rake is not needed.

As shown in FIG. 5, the number of applicator rakes may correspond to the number of mixing heads 100, 110, 120.

The three applicator rakes 500 and 520 are arranged essentially side-by-side in FIG. 5. The fact that the middle, prior-art applicator rake is offset backwards slightly is intended to show that such applicator rakes have certain space requirements that may preclude direct side-by-side positioning. The applicator rakes 520 may also be arranged, for example, at angles ≤80° to the direction of motion 610 of the outer layer 10.

In FIG. 5, the feeding of the reaction mixture from the discharge conduits 310 of the mixing heads 100, 110 and 120 into the applicator rakes is in each case effected at the end of the applicator tube, in particular at the two outer asymmetric applicator rakes 520 at the end with the non-enlarged hole diameters.

FIG. 6 shows by way of example the discharge quantities from a symmetrical applicator rake 510 corresponding to FIG. 1. Employed here was a symmetrical applicator rake which has on both sides in each case 2 discharge openings with larger diameters and thus higher discharge quantities (1, 2 and 19, 20). The distributor channel cross section is in this case constant and the applicator rake has 20 holes.

FIG. 7 shows by way of example the discharge quantities from a discharge apparatus comprising 2 asymmetric applicator rakes 520 according to FIG. 2 and a conventional applicator rake 500 arranged as shown in FIG. 6. The two asymmetric applicator rakes of type B (discharge opening A1 to A20/C1 to C20) have at their respective outer end, pointing towards the outer layer edge, of the applicator tube 2 discharge openings having larger diameters which thus exhibit higher discharge quantities (A1, A2 and C19, C20). The distributor channel cross section is constant in each case; each applicator rake has 20 holes.

The implementation of the invention is not restricted to the preferred exemplary embodiments specified above. By contrast, a number of variants are conceivable which make use of the specified solution even in fundamentally different designs. All of the features and/or advantages arising from the claims, the description or the drawings, including constructional details or spatial arrangements, may be essential to the invention within the scope of the claims both by themselves and in various combinations.

### LIST OF REFERENCE SYMBOLS

Reference symbols used for all figures:
10 outer layer
20 apparatus
100, 110, 120 mixing heads
230 distributor
250 distributor channel
300 discharge conduit from distributor to applicator rake
310 discharge conduit from mixing head
500 conventional applicator rake
510 inventive applicator rake of type A
520 inventive applicator rake of type B
530 feed to applicator rake
550 discharge opening with normal discharge
560 discharge opening with increased discharge
580 end of applicator rake with increased discharge quantity
600 foam layer
610 direction of motion of outer layer 10
700 central region of applicator rake
900 detail view of end of applicator rake
FA hole cross section
FA1 hole cross section of outermost hole with additional discharge
FA2 hole cross section of second outermost hole with additional discharge
DA hole diameter
DA1 hole diameter of outermost hole with additional discharge
DA2 hole diameter of second outermost hole with additional discharge
LA Hole length

1. An applicator rake for applying a liquid reaction mixture to an outer layer comprising a distributor channel and a plurality of discharge openings, wherein the geometry of the discharge openings of the applicator rake is such that the average discharge quantity per unit length along the longitudinal extent of the applicator rake is at at least one end of the applicator rake 1.1 to 3 times greater than the average discharge quantity per unit length in the central region of the applicator rake, wherein the end of the applicator rake is to be understood as meaning the outer quarter or less of a tube of the applicator rake in its longitudinal extent and wherein the central region of the applicator rake is to be understood as meaning the remaining region of the applicator rake.

2. The applicator rake as claimed in claim 1, wherein 1 to 6 discharge openings are disposed at the at least one end of the applicator rake.

3. The applicator rake as claimed in claim 1, wherein the discharge openings are drilled holes attached perpendicular to a tube axis and/or tubelets attached perpendicular to the tube axis.

4. The applicator rake as claimed in claim 1, wherein at at least one end, the discharge quantity for the outer discharge openings is 1.2 to 2 times the quantity for the other discharge openings.

5. The applicator rake as claimed in claim 1, wherein the cross-sectional area FA of at least one discharge openings at the at least one end is 1.05 to 2 times larger than the average cross-sectional area of the discharge openings in the central region of the applicator rake.

6. The applicator rake as claimed in claim 5, wherein the cross-sectional area FA is circular and has a diameter DA, wherein the diameter DA is 1.025 to 1.41 times larger than the average diameter of the discharge openings in the central region of the applicator rake.

7. The applicator rake as claimed in claim 1, wherein the average hole length of the discharge openings at the at least one end is smaller than the average hole length LA of the other discharge openings in the central region of the applicator rake.

8. The applicator rake as claimed in claim 1, wherein the average distance between the discharge openings in the region of the at least one end of the applicator rake is smaller than the distance between the discharge openings in the central region of the applicator rake.

9. An application apparatus for producing a composite element from at least one outer layer and a core layer, comprising an applicator rake as claimed in claim 1.

10. The application apparatus as claimed in claim 9, comprising precisely one applicator rake, wherein the geometry of the discharge openings of the applicator rake is such that the average discharge quantity per unit length at both ends of the tube is greater than in the central region of the applicator rake and said rake is arranged substantially transverse to the direction of motion of the outer layer.

11. The application apparatus as claimed in claim 9, comprising at least one applicator rake, wherein the geometry of the discharge openings of the at least one applicator rake is such that the average discharge quantity per unit length at precisely one end of the tube is greater than in the central region of the at least one applicator rake, wherein the at least one applicator rake is positioned in the application apparatus such that a greater discharge quantity is applied towards the edge of the outer layer.

12. The application apparatus as claimed in claim 11, comprising two applicator rakes, wherein the geometry of the discharge openings of the two applicator rake is such that the average discharge quantity per unit length at precisely one end of the tube is greater than in the central region of the two applicator rake, and wherein said openings are arranged such that ends with the increased discharge quantities each effect application to a respective edge of the outer layer.

13. The application apparatus as claimed in claim 9, wherein the number of discharge openings per applicator rake in the apparatus is 12/m to 125/m.

14. A process for producing foam composite elements with the application apparatus as claimed in claim 9, wherein the process comprises applying a liquid reaction mixture to an outer layer.

15. The process as claimed in claim 14, wherein the reaction mixture contains
a polyisocyanate B), and
an isocyanate-reactive composition A) containing
at least one polyol A1), and
optionally other isocyanate-reactive compounds A2), and
optionally additives and auxiliaries A3),
optionally catalysts D), and
one (or more) blowing agents C).

16. The applicator rake as claimed in claim 5, wherein the cross-sectional area FA of at least two discharge openings at the at least one end is 1.05 to 2 times larger than the average cross-sectional area of the discharge openings in the central region of the applicator rake.

17. The applicator rake as claimed in claim 5, wherein the cross-sectional area FA of at least one discharge opening at the at least one end is 1.1 to 1.5 times larger than the average cross-sectional area of the discharge openings in the central region of the applicator rake.

18. The applicator rake as claimed in claim 6, wherein the cross-sectional area FA is circular and has a diameter DA, wherein the diameter DA is 1.1 to 1.25 times larger than the average diameter of the discharge openings in the central region of the applicator rake.

19. The application apparatus as claimed in claim 13, wherein the number of discharge openings per applicator rake in the apparatus according to the invention is 30/m to 75/m.
